(19) United States
(12) Patent Application Publication
(10) Pub. No.: US 2012/0068534 A1
(43) Pub. Date: Mar. 22, 2012

(54) Power Supply System Including Alternative Sources-Control and Communication

(76) Inventor: Yang Pan, Shanghai (CN)

(21) Appl. No.: 13/304,707

(22) Filed: Nov. 28, 2011

Related U.S. Application Data
(63) Continuation-in-part of application No. 12/623,416, filed on Nov. 22, 2009.

(51) Int. Cl. H02J 4/00

(52) U.S. Cl. 307/26

(57) ABSTRACT

A power supply system comprises multiple power consumption units, a DC power distribution unit, a control unit and a centralized DC power storage unit. The DC power may be generated from alternative power sources. Each of the consumption units further comprises appliances that consume either AC or DC powers. Each of the appliances is assigned a priority to consume the generated DC power. The control unit allocates the generated DC power to the appliances according to their priorities. A communication network including communication units in the consumption units and a communication unit in the control unit is employed to exchange data among the consumption units and the control unit.

### CROSS-REFERENCE TO RELATED APPLICATIONS

The present application is a Continuation-In-Part of the application Ser. No. 12/623,416.

### BACKGROUND

1. Field of Invention

This invention relates to a power supply system, specifically to a power supply system including an AC source from a power grid and DC sources from local and remote alternative power sources.

2. Description of Prior Art

In recent years, concerns have been raised that high demand for electricity taxing the capacity of existing electricity generating plants. Furthermore, concerns regarding the availability and environmental safety of fossil and nuclear fuel are being raised. As a result of the above factors, the price of electricity has been on a path of steady increasing.

Furthermore, the electrical utility industry has for some time labored under the problem of supplying cost effective power to comply system peak-demand period requirements. The concept of peak-demand power supplementation is not new. A number of systems have been tested and implemented over years based upon batteries, hydroelectric, and combustion turbine. Each of the systems, by nature or by implementation, has had problems. Some are expensive and others are not acceptable environmentally.

Solar systems have been used with gained popularity to resolve at least partially the peak-demand issue of the power grid. A solar system may convert generated DC electricity from solar panels into AC electricity and be used to power electrical appliance. The generated DC power may be purchased by a power grid company after it is converted into AC power by utilizing an inverter. Over the years inverters have progressed from electromechanical to semiconductor devices. The use of the inverters not only causes the loss of electrical power but also the increase of overall cost of the solar system.

In addition to the solar systems, wind turbines have also been employed to provide clean energy. The wind turbine generates an AC power from the kinetic energy of the wind through a system comprises a rotator, a gearbox and a generator. The AC power is rectified into a DC power and is further converted into AC power with the same frequency as the AC power from the power grid. The inverter is used to convert the DC power into the AC power, which results in a loss of electricity and also in an increase in the cost.

Further, fuel cells are used to provide additional sources of clean energies.

It is desirable to have a system and method for utilizing alternative energies including the solar systems, the wind turbines and the fuel cells to supplement the AC power from the power grid while minimizing cost associated with the use of inverters.

### SUMMARY OF THE INVENTION

It is therefore an object of the present invention to provide a power supply system to minimize the use of the AC power from the power grid by consuming the DC power from local alternative power sources as the first priority and the DC power from remote alternative power sources as the second priority.

It is another object of the present invention to provide a means of maximizing the DC power consumption by assigning each of the appliances a priority of consuming the DC power by a control unit.

It is yet another object of the present invention to provide system and method of control and communication that enables maximizing of the DC power consumption.

The power supply system based upon the present inventive concept comprises a first means of power supply based upon AC power from the power grid, a second means of power supply based upon alternative power sources in remote sites and a third means of power supply based upon DC power generated from local alternative power sources. The alternative power sources may comprise the solar systems, the wind turbines and the fuel cells.

The power consumption unit may include multiple residential and/or commercial units. There may be two groups of electrical appliances in the units connecting to the power supply system. The first group of appliances receives the AC power supply only and the second group of appliances receives the AC and/or DC power supplies. A switch is used to connect the second group of appliances to the DC power as it is available. A power management device of the consumption unit comprises a demand detector for detecting required DC power for the second group of the appliances and a supply detector for detecting the available DC power. A controller controls an operation to maximize the DC power consumption. The units always consume the DC power either generated locally or generated remotely as the priority. According to one aspect of the invention, a battery may be used to store the surplus DC power. The battery may also be used as a supplementary for powering the appliances form the second group. According to another aspect of the invention, the surplus DC power generated by the local alternative sources may also be sent to the DC power distribution unit to power operations of electrical appliances of other power consumption units.

According to one aspect of the power supply system, a centralized control unit is employed to maximize the DC power consumption. Each of the appliances (from the second group) in the consumption units that consume either AC or DC powers is assigned a priority based upon predetermined rules in a sequential manner by the control unit. The control unit allocates the generated DC power from local and remote alternative power sources to the appliances according to their priorities. A communication network including communication units in the power management devices and a communication unit in the control unit is employed to exchange data among the consumption units and the control unit.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a schematic diagram of a power supply system comprising the AC power from a power grid and the DC power from local and remote alternative power sources.

FIG. 2 is a schematic diagram illustrating a layout of an exemplary implementation of the power supply system including a solar panel array and a wind turbine array as the remote alternative power sources.

FIG. 3 is a schematic diagram of the power consumption unit connected to both the AC and DC power sources.

FIG. 4 is a functional block diagram of a power management device of the power supply system.

FIG. 5 is a schematic diagram of the appliance that receives AC and/or DC power supplies.

FIG. 6 is a flow diagram depicting steps of the operation of the power supply system.

FIG. 7 is a flow diagram depicting steps of a process illustrating the operation of the power supply system when the generated DC power is no long a stable source.

FIG. 8 is a schematic diagram of a power supply system comprising a control unit, a centralized DC power storage unit and a communication unit.

FIG. 9 is a functional block diagram of a power management device of the power supply system including a communication unit.

FIG. 10 is a schematic diagram illustrating exemplarily that each of the appliances is assigned an identity.

FIG. 11 is a schematic diagram illustrating exemplarily that the control unit allocates the generated DC power to the appliances according to their priorities.

FIG. 12 is a schematic diagram illustrating exemplarily that the control unit moves one appliance from a list of the appliances receiving the generated DC power to a list of appliances receiving the AC power, when the generated DC power is reduced.

FIG. 13 is a flow diagram depicting steps of the operation of the control unit including the communication network.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

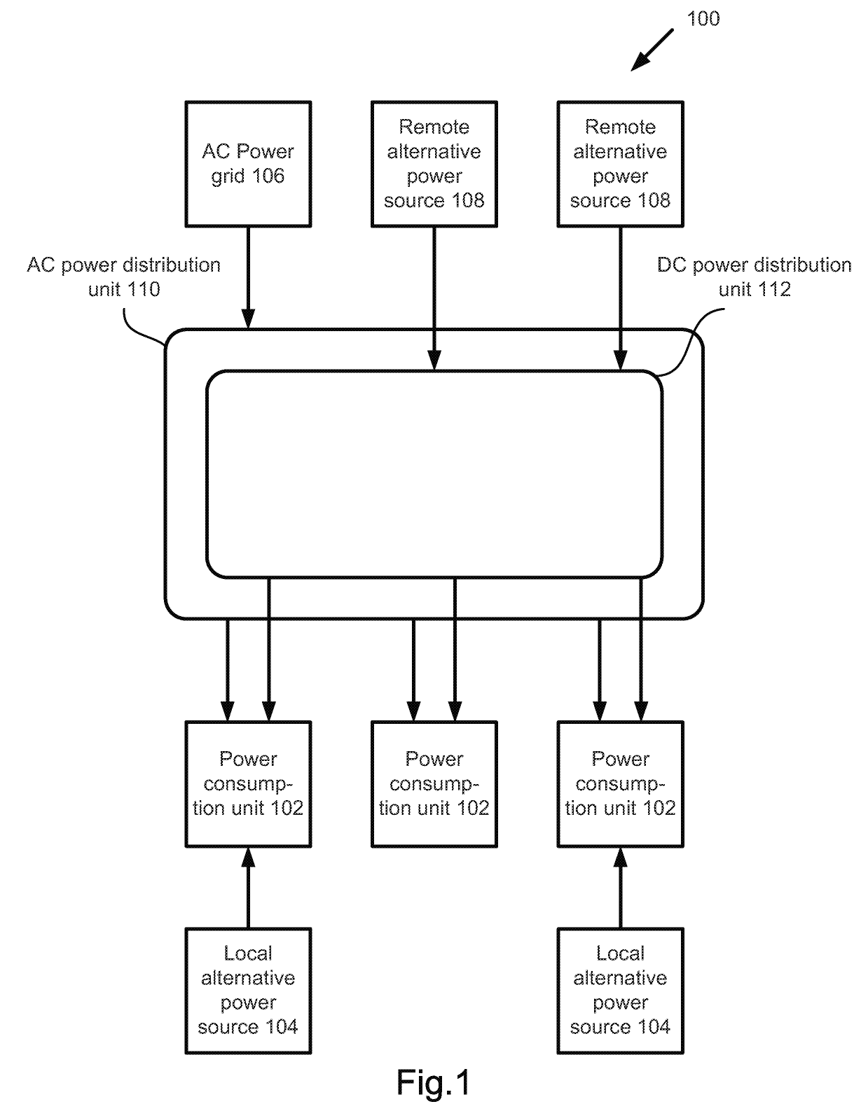

FIG. 1 is a schematic diagram of a power supply system. The system 100 comprises a plurality of power consumption units 102. The consumption unit 102 may be a residential unit such as for example, a house. The consumption unit 102 may also be a commercial unit such as for example, a shopping mall or an office. Some of the power consumption units may further be connected to a local alternative power source 104. 104 may be a solar system and/or a wind turbine providing the DC electrical power. The solar system generates the DC electrical output based upon well known photovoltaic effects. The wind turbine converts the kinetic energy into the mechanical energy by a rotator and a gearbox and further converts the mechanical energy into the AC electricity by a generator. The generated AC electricity is typically not in the same frequency as the AC electricity from a power grid and therefore cannot be consumed directly. A rectifier is used to convert the AC power into the DC power. In some applications, the DC power is further converted into the AC power with the same frequency as the power grid by an inverter. In the present invention, the DC power generated from the wind turbines may be employed directly. The cost of employing the alternative power source 104 is reduced significantly by eliminating the use of inverters. The system 100 further comprises an AC power grid 106 and one or multiple remote alternative power sources 108. 108 may be a solar system, a wind turbine system or a electro-chemical electricity generation system such as fuel cells. The AC power is distributed by an AC power distribution unit 110 including conventional AC power transmission lines. The generated DC power from the remote alternative power sources is delivered to the power consumption unit 102 through a DC power distribution unit 112. The DC power distribution unit 112 may comprise dedicated DC power transmission lines. Each power consumption unit 102 may be connected to both the AC and the DC power sources.

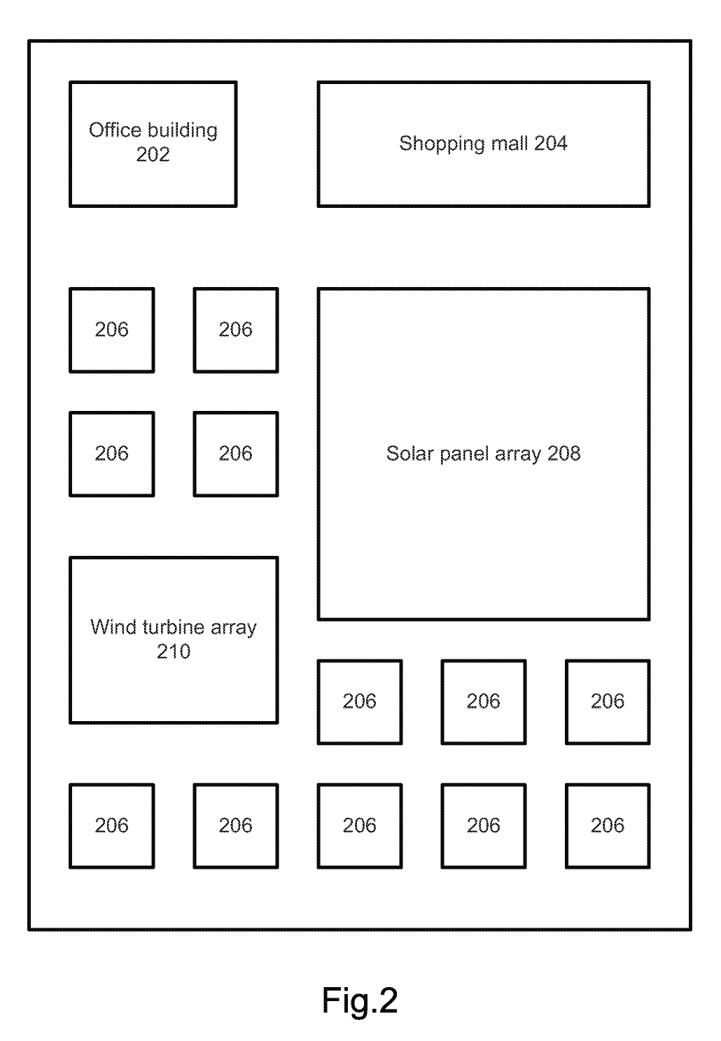

FIG. 2 is a schematic diagram illustrating some aspects of the power supply system 100. An exemplary layout of a residential area is illustrated. The area may include an office building 202, a shopping mall 204 and multiple residential units 206. In the exemplary case, the area includes two open spaces. One of them is used to install a solar panel array 208 and another is used to install a wind turbine array 210. The solar array 208 and the wind turbine array 210 generate DC electrical power. The generated power may be delivered to the commercial units 202/204 and the residential units 206 through the DC power distribution unit 112. The generated power may also be delivered to other power consumption units in other areas. It should be noted that solar systems may also be installed on the roof of each residential unit 206. The solar system may also be installed on the roof of the commercial units 202 and/or 204. The generated DC power from such a local DC power source may be consumed by electrical appliances in the unit.

The solar panel array 208 may be movable. There may be temporarily open space in a residential area. The space may be employed to generate electricity by moving-in a solar panel array. The generated electrical power may be consumed by the residential units near the array or be delivered to other units through the DC power distribution unit. The generated DC power is preferably consumed by the units nearby to prevent power loss during the transmission.

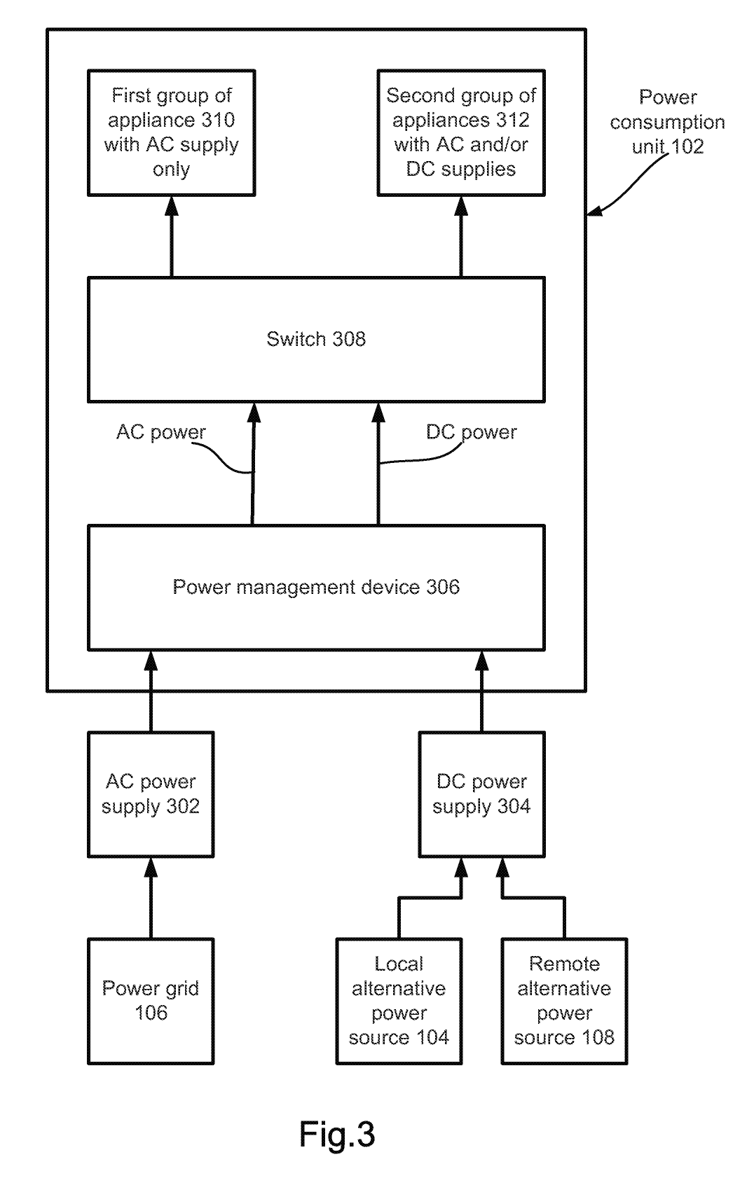

FIG. 3 is a schematic diagram of a power consumption unit connected to both the AC and DC power sources. The power consumption unit 102 is connected to an AC power supply 302 and a DC power supply 304. The AC power supply 302 supplies the AC power from the power grid 106. The DC power supply 304 supplies the DC power from the local alternative power source 104 and the remote alternative power source 108. The alternative power sources may comprise one or multiple solar systems. They may also comprise one or multiple wind turbines. If more than one power sources are used for the alternative source 104, the DC power supply 104 may include a feature to combine all DC power sources to convert into a single DC output.

The power consumption unit 102 further comprises a power management device 306 for processing the incoming powers from 302 and 304 and for delivering the processed power to the electrical appliances through a switch 308. There are two groups of electrical appliances used in the system 100. The first group of appliance 310 receives the AC power supply only. It means that the first group of appliances can only take the AC power for their operations. The AC power is the power from the power grid 106. The second group of appliance 312 receives the AC and/or the DC power supplies. It means that the appliances of the second group may receive both AC and DC power supplies for their operation. The second group of appliances, therefore, can consume DC power from the local alternative power source 104 and the remote alternative power source 108.

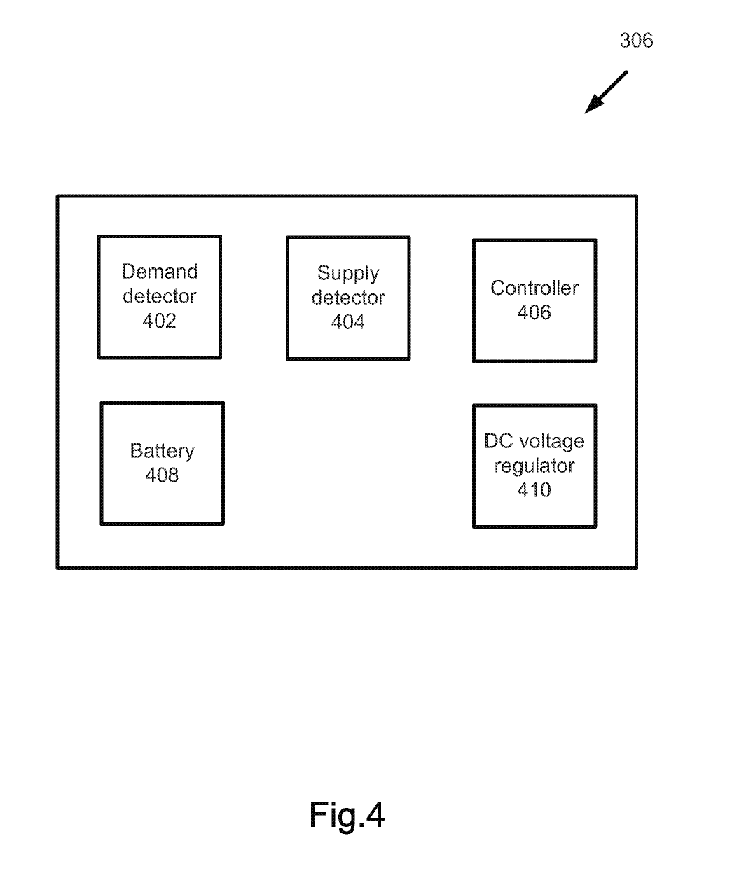

FIG. 4 is a functional block diagram of the power management device 306. The device 306 comprises a demand detector 402 and a supply detector 404. The detector 402 is used to detect the required DC power for the operations of the second group of appliances 312. The detector 404 is used to detect the DC power generated by the local alternative power source 104 and the DC power available from the remote alternative power source 108. The operations of detecting the demand and the supply are controlled by a controller 406. The controller 406 determines through the demand detector 402 the required DC power for all connected second group of appliances.

According to one aspect of the operation of the demand detector 402, the available DC power from 104 and 108 supplemented by the DC power drawn from a battery 408 may be used to supply temporarily DC power requirement for all connected appliances of the second group. The required DC power is therefore determined by adding the DC power drawn from 104/108 and from the battery 408. If the DC power is indeed required from the battery 408, the AC power from the power grid 106 will be used to replace the DC power from the battery. If the DC power is not required from the battery 408, the DC power generated from the alternative power sources 104/108 is sufficient for powering the appliances from the second group and the surplus DC power from the local source 104 will be stored in the battery 408. The detector 402 may be an operational procedure represented by a software module. 402 may also comprise hardware and/or firmware. It should be noted that the appliances from the first group are always powered by the AC power supply 302.

The battery 408 may be a re-chargeable battery. According to one implementation, 408 may be a deep-cycle re-chargeable battery as typically adopted for a solar system. According to another implementation, the battery 408 may also be charged by the AC power from the power grid 106. The power stored in the battery 408 may be used to power the appliances from the second group while the alternative power sources 104/108 do not supply the stable DC power such as for example, when solar systems cease to generate DC power at the night. The power stored in the battery 408 may be used at the night for the appliances from the second group. However, it should be noted that the battery 408 should reserve a minimum amount of power to support the operation of the power management device 406.

According to another aspect of the present invention, the surplus power generated by the local alternative power source 104 may also be sent to the DC power distribution unit 112 to power electrical appliances from the other power consumption units. Since the DC power is injected to the distribution unit directly, no inverter is required. Power loss because of the use of inverter can be avoided and the cost of distributing the DC electrical power generated by the alternative source can be reduced.

A DC voltage regulator 410 is also included in the device 306 as shown in FIG. 4. The DC power supply 304 generated from the alternative power sources 104/108 may need to be regulated before it is consumed by the electrical appliances.

Because the AC power from the power grid 106 is always available for the system 100, the controller 406 has a feature to use the AC power as a backup power whenever it is required such as for example, when the local and remote alternative power sources are malfunction due to technical problems. It is important that such a default feature is implemented to prevent disruption of operations of the appliances.

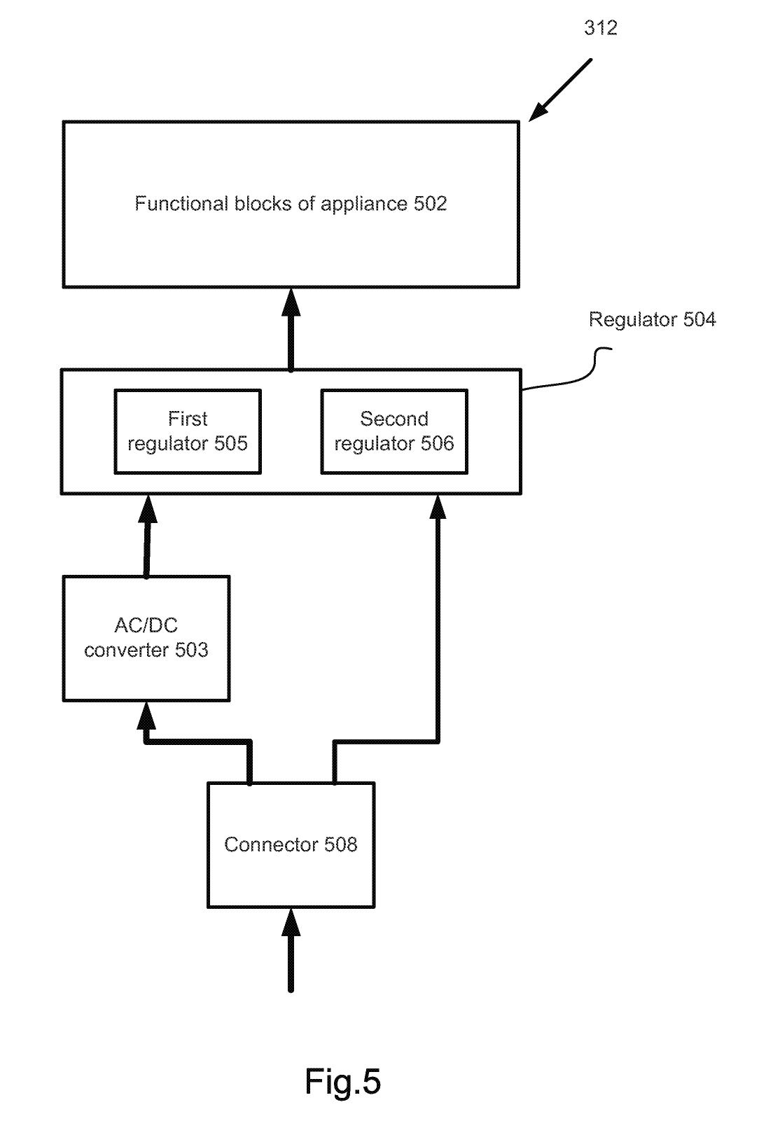

Functional blocks of an exemplary appliance 312 from the second group are further illustrated in FIG. 5. Block 502 represents all functional blocks of the appliance except for the power supply unit of the appliance. The power supply unit comprises an AC path including an AC/DC converter 503 and a voltage regulator 504. The regulator 504 comprises a first voltage regulator 505 for regulating the output voltage from the AC/DC converter 503 for the operation of 502. The unit further comprises a DC path for receiving power from the alternative power sources 104/108 through the power management device 306 and the switch 308. The received DC power may be further regulated by the voltage regulator 504 including the second voltage regulator 506 to satisfy the voltage requirement of 502. The two power paths are connected to the appliance through a connector 508 including one connection mechanism for AC power and another connection mechanism for the DC power. The connection mechanisms may be implemented in a similar manner as a conventional electrical plug and slot.

According to one aspect of the present invention, one of the two power paths is selected by the controller 406 of the power management device 306. The selection is based upon the generated and required DC power. If the DC path is selected, 502 is connected by the connector 508 to the DC power supply 304 through the power management device 306 and the switch 308. If the AC path is selected, 502 is connected by the connector 508 to the AC power supply 302.

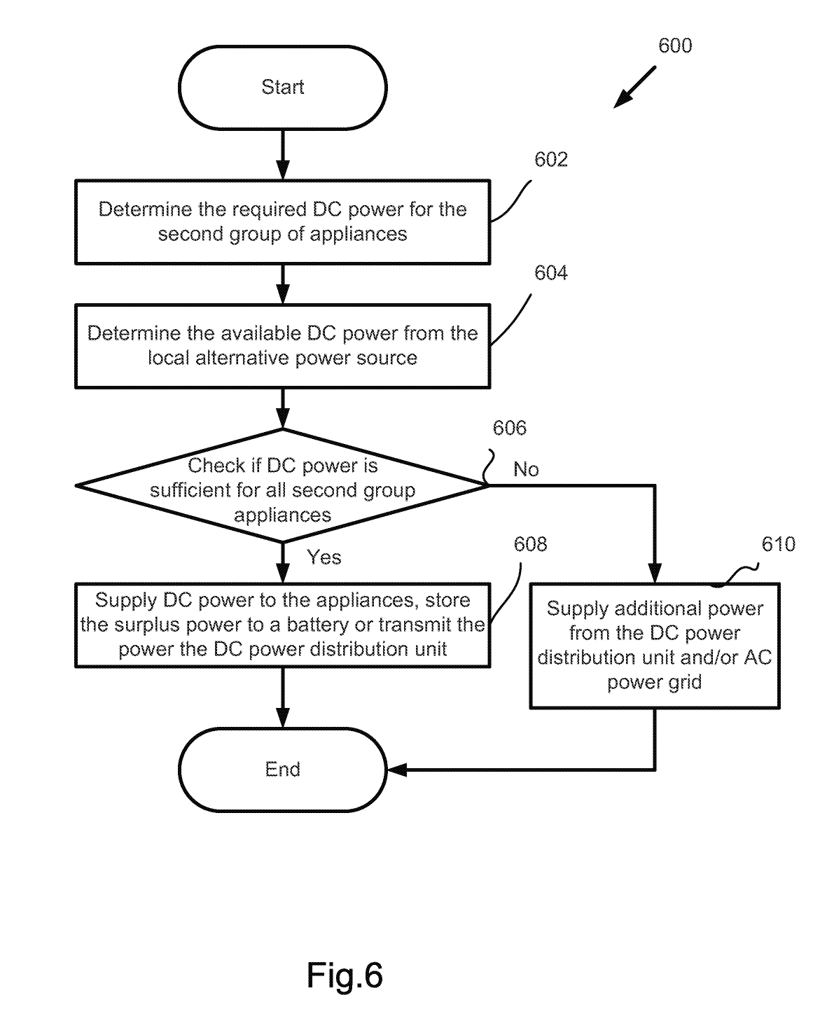

FIG. 6 is a flow diagram depicting steps of a process illustrating an exemplary operation of the power supply system 100. Process 600 starts with step 602 that the DC power required for powering all second group appliances from the consumption unit is determined by the demand detector 402 controlled by the controller 406. The generated DC power from the local alternative power source 104 is determined in step 604 by the supply detector 404. In step 606, the controller 406 checks if the generated DC power is sufficient for powering all the second group appliances. If the result is positive, the DC power is directed in step 608 to power the appliances and the surplus power is either stored in the battery 408 or sent to the DC power distribution unit 112. If the result is negative in step 606, all generated DC power is consumed and additional DC power from the remote alternative source 108 and/or from the AC power grid 106 are used to supplement the second group appliances 312 in step 610.

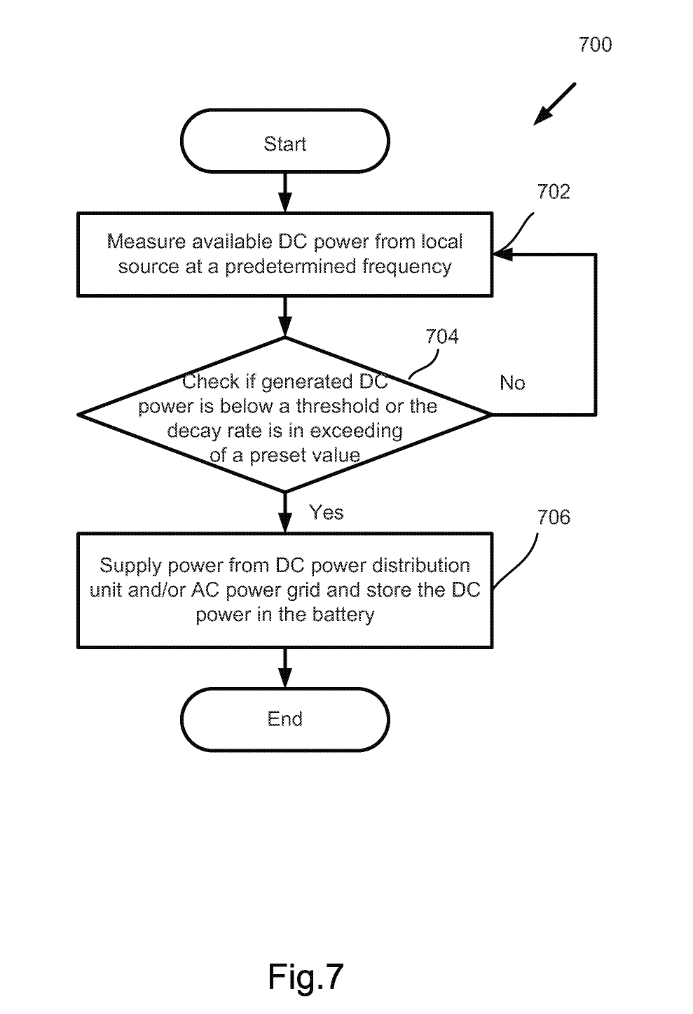

FIG. 7 is a flow diagram depicting steps of a process 700 illustrating an exemplary operation of the power supply system 100 when the generated DC power from the local alternative source 104 is no longer a stable one. The process 700 starts with step 702 that the generated DC power from 104 is measured by the supply detector 404 in a predetermined frequency such as for example, every five minutes. In step 704, the controller 406 checks if the generated DC power is below a threshold or the decay rate of the DC power is in exceeding of a preset value. If the solar system is employed in the local alternative power source 104, the generated DC power is reduced quickly when it is near the sunset. If the result is positive according to the step 704, the additional DC power from the remote alternative source 108 and/or the AC power from the power grid 106 are directed to the second group appliances being powered by the DC power from the local source 104 in step 706. The generated DC power, although unstable, may still be stored in the battery 408. The generated DC power may also be simply abandoned.

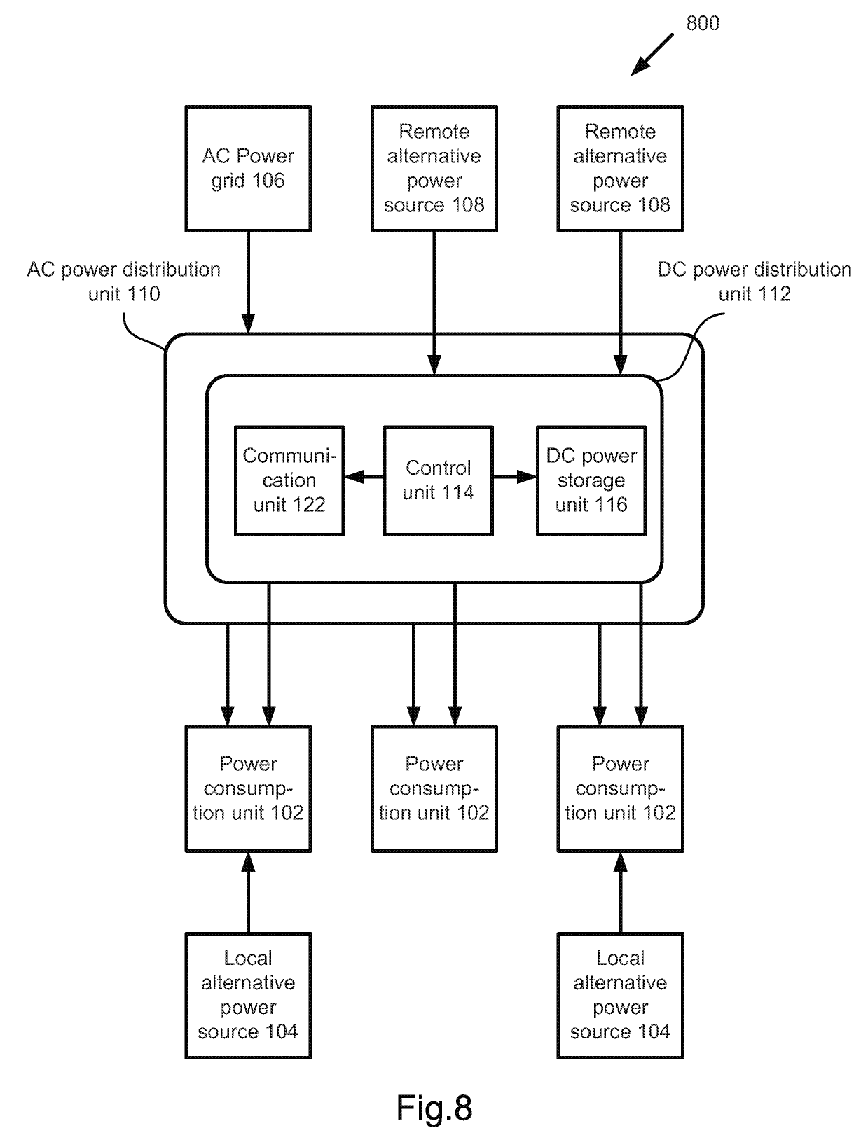

Another aspect of system 100 is illustrated in FIG. 8. System 800 comprises a control unit 114. Control unit 114 comprises a computing system in an exemplary case. Control unit 114 includes hardware, software and firmware. Control unit 114 may be a centralized unit according to one implementation. Control unit 114 may also be a distributed unit comprising multiple computing systems. Control unit 114 further comprises a file storage system (not shown in the figure) as commonly used in the computing system.

System 800 further comprises a communication unit 122. Communication unit 122 is used to form a communication network with communication units in the power management devices in the consumption units 102. According to one implementation, the communication network is an ad hoc communication network including but not limiting to: 1) a Bluetooth type of network (IEEE 802.15.1 and its extensions); 2) a ZigBee type of network (IEEE 802.15.4 and its extensions); and 3) a Wi-Fi type of network (IEEE 802.11 and its extensions). The communication network may also be a telephone network, such as for example, a telephone network using 3G or 4G standard. The communication network may be the Internet.

Since both AC and DC distribution units (110 and 112) comprise power transmission lines, a Power Line Communication protocol may also be employed. Power Line Communication or Power Line Carrier (PLC), also known as Power Line Digital Subscriber Line (PDSL) is a system for carrying data on a conductor also used for electrical power transmission.

Communication unit 122 may further comprise a communication device for connecting the control unit 114 to a control station for the AC power grid 106 through a communication link. The control unit 114 of the power supply system 800 may inform the control station of the power grid 106 its power supply and demand status. The control station of the power grid may instruct the control unit 114 through the communication link to convert by a centralized inverter of the power supply system 800 the surplus DC power to the AC power and to inject the AC power to the power grid 106 if there is a shortage of the power from the power grid 106.

System 800 may also comprise a centralized power storage unit 116 for storing the surplus DC power generated from the alternative power sources.

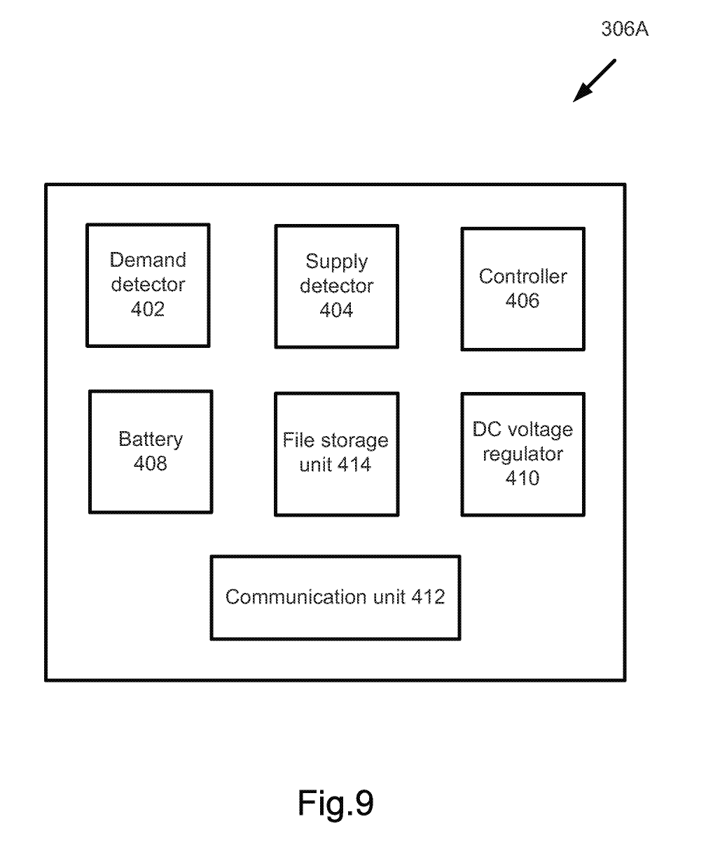

FIG. 9 is a functional block diagram of a power management device 306A of the power supply system 800 according to another implementation. The power management device 306A comprises a communication unit 412. Communication unit 412 conforms to the same communication standards as the communication unit 122. The power management device 306A may further comprise a file storage system 414. File storage system 414 may comprise semiconductor memory devices such as flash memories. System 414 may also comprise magnetic storage devices and optical storage devices. System 414 may also include a cache for improving accessing time.

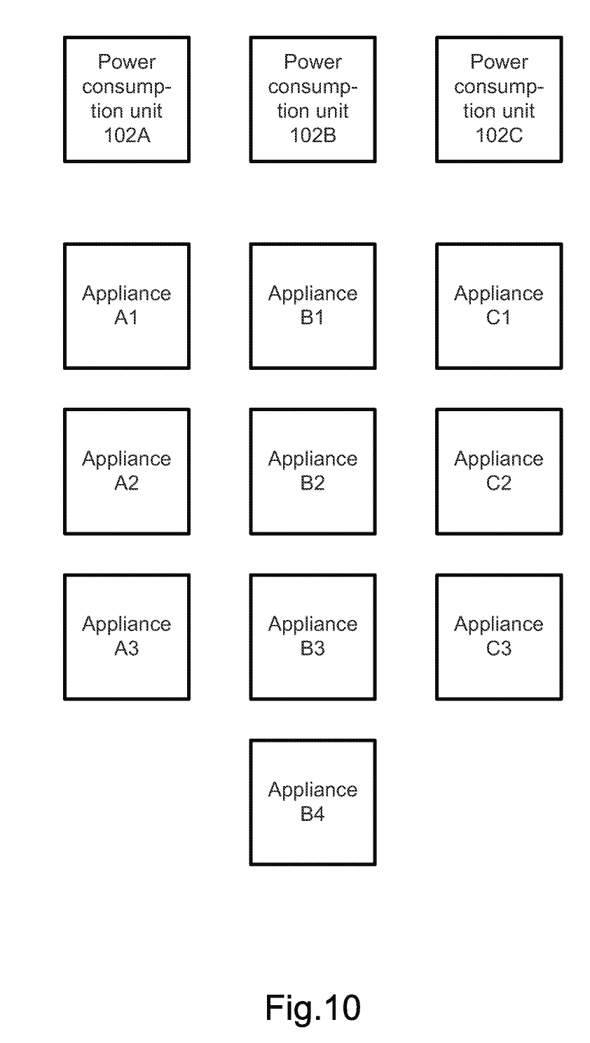

FIG. 10 is a schematic diagram illustrating exemplarily that each of the appliances 312 is assigned an identity. More or less appliances 312 and more or less consumption units 102 may be used in the system 800 as obvious to one with ordinary skill in the art. The power management devices 306A send the identities of the appliances 312 to the control unit 114 after formation of the communication network. The control unit 114 receives the identities and determines the priorities according to predetermined rules. The rules may include but not limit to: 1) minimizing DC power loss during transmission and 2) maximizing revenue by accepting better prices from the consumption units.

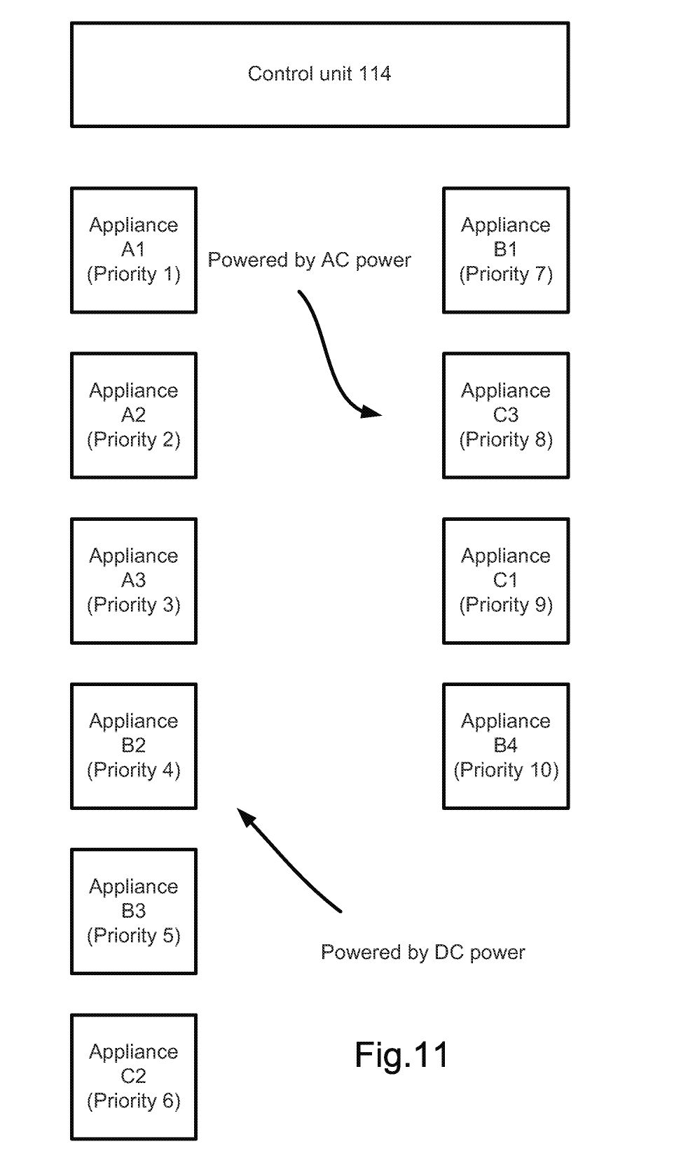

FIG. 11 is a schematic diagram illustrating exemplarily that the control unit 114 allocates the generated DC power to the appliances 312 according to their priorities. According to the exemplary case, the generated DC power is insufficient to power all of the appliances 312 in the consumption units 102. As a result, some of the appliances 312 are powered by the AC power. The control unit 114 sends the list to the power management devices 306A through the communication network. The power management devices 306A connect the appliances 312 to either the DC power or the AC power according to the received list.

The list may be changed whenever there is a change in the generated DC power. The list may also be changed when one or more appliances 312 are switched on or off in anyone of the consumption units 102. The changes of the status of the appliances 312 are detected by the power management devices 306A. The changes of the status of the appliances 312 are subsequently sent to the control unit 114. The control unit 114 adjusts the list according to the changes.

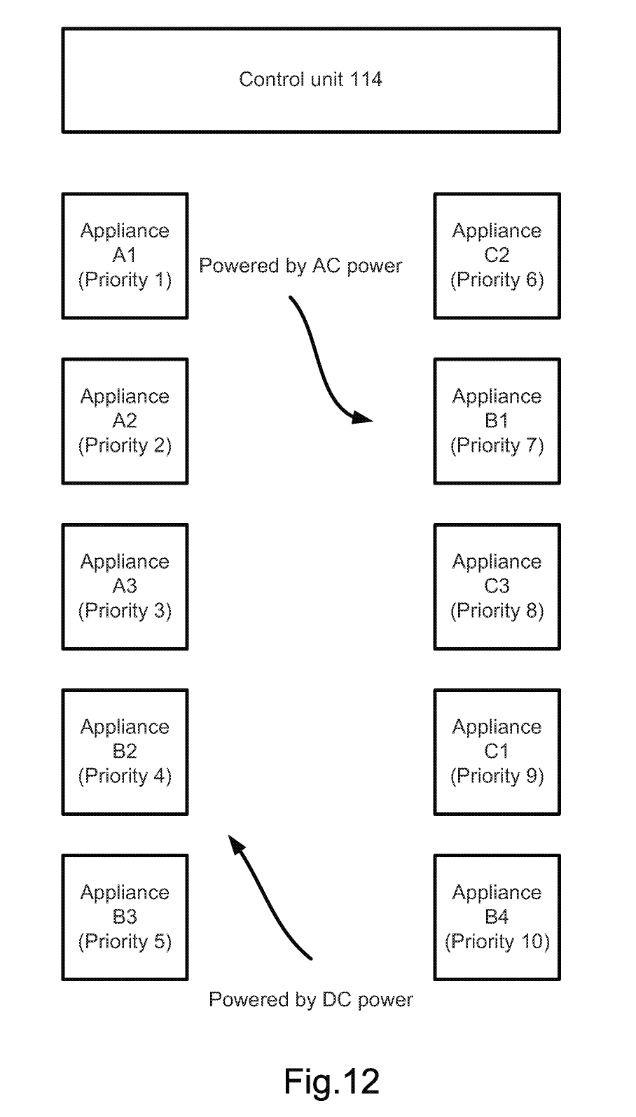

FIG. 12 is a schematic diagram illustrating exemplarily that the control unit 114 moves one appliance from the list of the appliances 312 receiving the DC power to the list of the appliances 312 receiving AC power, when the available DC power is reduced.

It should be noted that when a new appliance 312 is switched on in a consumption unit 102, the appliance 312 may be powered by the AC power temporarily or be powered by a local power storage unit such as a battery 408 until an instruction is received by the power management device 306A from the control unit 114. The instruction may direct the power management device 306A to connect the new appliance 312 either to the DC power or to the AC power. The system 800 may also include a portion of DC power as a buffering DC power to handle fluctuation in demanding of the DC power.

AC power is always backup power for the appliances 312. The power management device 306A may always connect the appliances 312 to the AC power if there is any uncertainty in the system 800 such as for example if the control or communication system is malfunctioning.

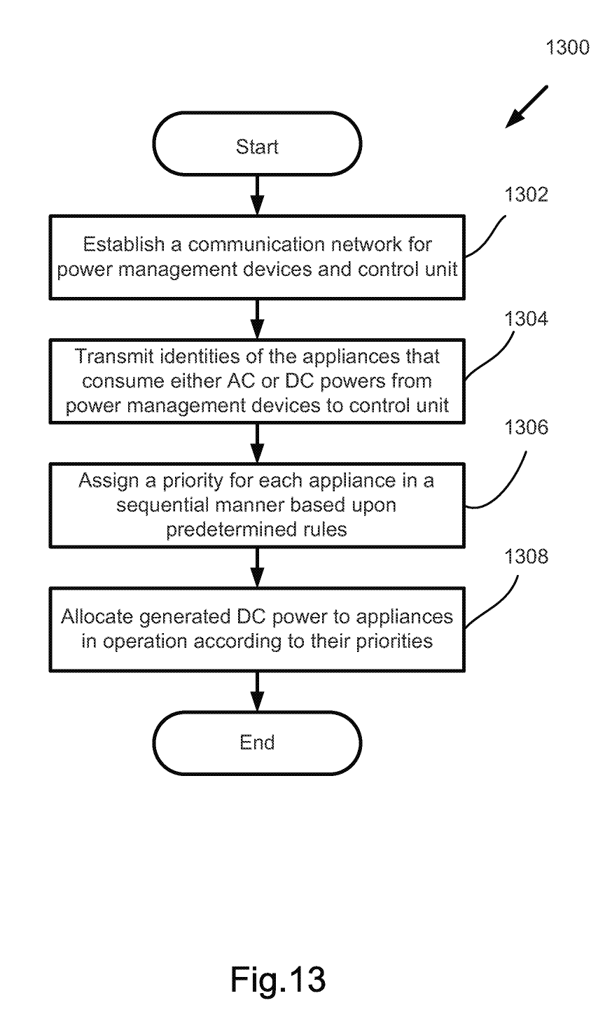

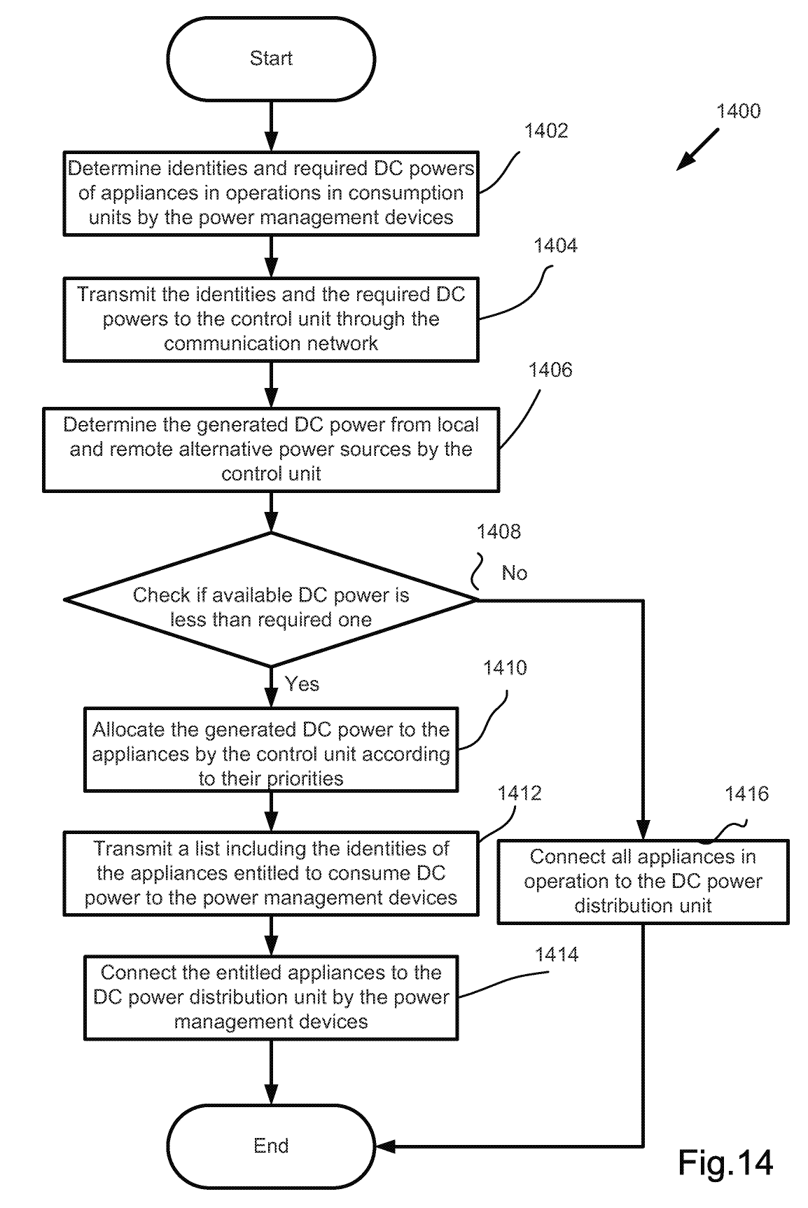

FIG. 13 is a flow diagram depicting process 1300 describing steps of the operation of system 800. A communication network is established by communication units 412 in the power management devices 306A and by a communication unit 122 in the control unit 114 in step 1302. The identities of the appliances 312 that receive either AC or DC powers are transmitted from the power management devices 306A to the control unit 114 in step 1304. The control unit 114 assigns each of the appliances 312 a priority based upon predetermined rules in a sequential manner for consuming DC power in step 1306. In step 1308, the control unit 114 determines the generated DC power from local and remote alternative power sources (104 and 108) and allocates the generated DC power to the appliances 312 in operations according to their priorities.

FIG. 14 is a flow diagram depicting process 1400 describing detailed steps of allocating the generated DC power to appliances 312 in operations. In step 1402 the identities and required DC powers of the appliances 312 in operations are determined by the power management devices 306A. Data files including the determined identities and the required DC powers are sent from the power management devices 306A to the control unit 114 in step 1404. The available DC power generated by local and remote alternative power sources (104 and 108) is determined by the control unit 114 in step 1406. The control unit 114 checks if the generated DC power is less than the required DC powers from all consumption units 102 in step 1408. If the result is positive, the control unit 114 allocates the generated DC power to the appliances 312 in operations according to their priorities in step 1410. A list of devices entitled to consume the generated DC power is created. The communication unit 122 of the control unit 114 sends the list to the power management devices 306A in step 1412 through the communication network. The power management devices 306A receive the list and connect the appliances 312 to the DC power distribution unit 112 according to the list in step 1414. The appliances 312 that are not entitled to consume the DC power are connected to the AC power distribution unit 110.

If the result is negative in step 1408, the control unit 114 sends an instruction to the power management devices 306A and the power management device 306A connects all the appliances 312 in operations to the DC power distribution unit 112 in step 1416. The surplus DC power may be stored in the centralized DC power storage unit 116. The surplus DC power may also be converted to AC power through a centralized inverter and is injected to AC power grid subsequently.

1. A power supply system comprising:
(a) a plurality of power consumption units, wherein said units further comprising a plurality of appliances that consume either AC or DC powers, wherein each of said units further comprising a power management device;
(b) a plurality of alternative power sources for generating DC power including sources in the consumption units and/or sources remotely located to the consumption units;
(c) a DC power distribution unit for distributing DC power; and
(d) a control unit comprising a means of maximizing the generated DC power consumption by assigning each of the appliances a priority for consuming the generated DC power in a sequential manner based upon predetermined rules.

2. The system as recited in claim 1, wherein said means of maximizing of the generated DC power consumption by the control unit further comprising allocating the generated DC power to the appliances according to said priority.

3. The system as recited in claim 1, wherein said system further comprising a communication network comprising communication units in the power management devices and a communication unit in said control unit.

4. The system as recited in claim 3, wherein said communication network further comprising an ad hoc communication network conforming to one or a combination of following standards:
(a) Bluetooth;
(b) ZigBee; and
(c) Wi-Fi.

5. The system as recited in claim 3, wherein said communication network further comprising one or a combination of the follows:
(a) a telephone network ;
(b) a power line communication network; and
(c) the Internet.

6. The system as recited in claim 1, wherein each of the appliances is assigned an identity.

7. The system as recited in claim 1, wherein said predetermined rules for assigning said priority further comprising one of or a combination of the follows:
(a) minimizing the generated DC power loss during transmission through the DC power distribution unit; and
(b) maximizing revenue by accepting better offered prices from the consumption units for consuming the generated DC power.

8. The system as recited in claim 1, wherein said priority is changeable by the control unit based upon said predetermined rules.

9. The system as recited in claim 1, wherein each of the power management devices further comprising a file storage system.

10. The system as recited in claim 1, wherein the control unit further comprising a file storage system.

11. The system as recited in claim 1, wherein said system further comprising a centralized DC power storage unit for storing at least a portion of the generated DC power.

12. The system as recited in claim 1, wherein said alternative power sources further comprising one or a combination of the follows:
(a) solar systems;
(b) wind turbines; and
(c) fuel cells.

13. A power management method for a power supply system comprising a plurality of power consumption units including appliances that consume either AC or DC powers, a DC power distribution unit, a control unit and a plurality of alternative power sources for generating DC power, the method comprising:
(a) establishing a communication network by communication units in power management devices of the consumption units and a communication unit in the control unit;
(b) transmitting identities of the appliances from the power management devices to the control unit through said communication network;
(c) assigning each of the appliances a priority based upon predetermined rules in a sequential manner for consuming the generated DC power; and
(d) allocating the generated DC power to each of the appliances according to said priority.

14. The method as recited in claim 13, wherein said step of allocating the generated DC power further comprising:
(a) determining identities and required DC powers of a plurality of appliances in operation by the power management devices;
(b) transmitting determined identities and the required DC powers to the control unit through the communication network;
(c) determining the generated DC power from the alternative power sources;
(d) determining appliances entitled to consume the generated DC power according to said priority;
(e) transmitting a list that includes the identities of the entitled appliances to the power management devices through the communication network; and
(f) connecting the entitled appliances by the power management devices to the DC power distribution unit to receive the generated DC power.

15. The method as recited in claim 13, wherein said method further comprising disconnecting one or a plurality of appliances from the DC power distribution unit by the power management devices according to said priority if the generated DC power is reduced, wherein the power management devices receive an instruction from the control unit.

16. The method as recited in claim 13, wherein said method further comprising connecting one or a plurality of appliances to the DC power distribution unit by the power management devices according to said priority if the generated DC power is increased, wherein the power management devices receive an instruction from the control unit.

17. The method as recited in claim 13, wherein said predetermined rules for assigning said priority further comprising one of or a combination of follows:
(a) minimizing the generated DC power loss during transmission through the DC power distribution unit; and
(b) maximizing revenue by accepting better offered prices from the consumption units for consuming the generated DC power.

18. The method as recited in claim 13, wherein said method further comprising changing said priority of the appliances based upon said predetermined rules.

19. The method as recited in claim 13, wherein said method further comprising connecting the appliances that are not entitled to consume the generated DC power to an AC power distribution unit by the power management devices.

20. The method as recited in claim 13, wherein said method further comprising connecting the appliances to the AC power distribution unit or to a local DC power storage device until a decision from the control unit is received by the power management devices.
